(19) United States
(12) Patent Application Publication
(10) Pub. No.: US 2022/0235266 A1
(43) Pub. Date: Jul. 28, 2022

(54) LIGHT EMITTING ELEMENT WITH EMISSIVE SEMICONDUCTOR NANOCRYSTAL MATERIALS AND PROJECTOR LIGHT SOURCE BASED ON THESE MATERIALS

(71) Applicant: Sony Group Corporation, Tokyo (JP)

(72) Inventors: Nadejda KRASTEVA, Stuttgart (DE); Garbriele NELLES, Stuttgart (DE); Dennis CHERCKA, Stuttgart (DE); Clemens WALL, Stuttgart (DE)

(73) Assignee: Sony Group Corporation, Tokyo (JP)

(21) Appl. No.: 17/611,440

(22) PCT Filed: Mar. 13, 2020
(86) PCT No.: PCT/EP2020/056964

§ 371 Date: Nov. 15, 2021

(30) Foreign Application Priority Data
May 23, 2019 (EP) 19176162.6

(51) Int. Cl. C09K 11/88; C09K 11/02; G03B 21/20

(52) U.S. Cl. CPC C09K 11/883; G03B 21/204; C09K 11/02

(57) ABSTRACT

Active materials for light emitting elements useful for light source apparatus and projector devices and provided. In particular, a light emitting element includes emissive semiconductor nano(crystal)material(s) (NC) and high-refractive index material. Further, a light source apparatus includes at least one light emitting element according to the present disclosure. The present disclosure also relates to a projector device, including a light source apparatus, including at least one light emitting element according to the present disclosure. Moreover, the present disclosure relates to methods of obtaining respective semiconductor nano(crystal)material (NC) films.

### BACKGROUND

The field of the DISCLOSURE lies in active materials for light emitting elements useful for light source apparatus and projector devices.

The present disclosure relates to a light emitting element comprising emissive semiconductor nano(crystal)material(s) (NC) and high-refractive index material.

The present disclosure also relates to a light source apparatus, comprising at least one light emitting element according to the present disclosure.

The present disclosure also relates to a projector device, comprising a light source apparatus, comprising at least one light emitting element according to the present disclosure.

Moreover, the present disclosure relates to methods of obtaining respective semiconductor nano(crystal)material (NC) films.

### DESCRIPTION OF THE RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

In recent years, projector devices using solid state light sources, e.g. light emitting diodes LED or laser diodes LD, have become state-of-the-art technology. In some projector devices, LD are used as direct light sources, while in other cases the light from LD or LED source is used to excite an emissive material which emits fluorescent light within a specific wavelength range due to the excitation by the LD or LED light source.

Known emissive materials comprise inorganic phosphor materials, e.g. yellow-green emitting yttrium-aluminium-garnet (YAG) based material, or a combination of red and green emitting phosphor materials. A disadvantage of inorganic phosphor materials is their broad emission spectrum (e.g. for YAG-based materials). Especially the limited emission in the red compared to the green spectral region leads to limitations in the achievable colour rendering index.

Semiconductor emissive nano(crystal) materials (NC) are being explored as (electro-) luminescent materials in several lighting applications, e.g. LED, OLED, flat-panel displays, as well as an active material in emissive display colour filters.

A new/emerging application of NC materials is as an emissive source in projector devices, where the usage of NC materials aims improving the spectrum efficiency and the colour gamut compared to state-of-the-art inorganic phosphor materials used to date. The advantage of NC for projector application is their narrow spectral emission (FWHM˜20-40 nm), high internal quantum efficiency (quantum yield up to ˜95%), as well as the possibility to tune the emission wavelength in the visible range by changing the composition and the structure of the NC.

In one approach to realize a NC-based projector emissive source, the NC nanocrystals are dispersed in a matrix (polymeric or inorganic) to form a thin composite film. The NC are excited by an incident laser beam with a specific wavelength and at specific excitation power and the resulting photoluminescent light is collected. Typically a NC content of a few volume percent in the film is needed in order to achieve sufficient external quantum efficiency of the NC source, and to reach the required brightness and colour gamut of the projector light source.

The internal quantum efficiency of NC nanocrystals has achieved near 100% however, the external quantum efficiency of NC-based light source remains below ˜15% because of losses due to concentration dependent multi-particle effects, e.g. re-absorption of the emitted photoluminescent light; emission quenching due to resonant energy transfer between neighbouring NC, non-radioactive relaxation processes (e.g. Auger recombination) or thermal quenching due to local heating of the NC; low efficiency of the excitation light in-coupling and the emitted light out-coupling from the NC-containing material.

### SUMMARY

It is provided a light emitting element capable of obtaining a high output and having excellent structural stability, a light source apparatus including the light emitting element, and a projector.

The present disclosure provides a light emitting element, comprising (1) emissive semiconductor nano(crystal)material(s) (NC) (2) high-refractive index material, and (3) binder in which the NC material and the high refractive index material are embedded.

The present disclosure provides a light source apparatus, comprising

(i) a light source, and

(ii) at least one light emitting element according to the present disclosure, or a plurality of light emitting elements according to the present disclosure.

The present disclosure provides a projector device, comprising

(i) a light source apparatus according to the present disclosure,

(ii) a light modulation element, and

(iii) a projection optical system.

The present disclosure provides a method of generating a thin layer or film comprising (1) a NC material, said thin layer or film comprising (2) high-refractive index material and (3) binder,

optionally other additives, which are deposited on a substrate,
said method comprising the steps of
mixing the NC material with the binder material,
ad-mixing high-refractive index particulate material,
depositing the above mixture on the substrate by spin coating, drop casting, doctor blading, and/or screen printing,
curing of the deposited NC material/high-refractive index particles/binder film.

In one embodiment of the method of generating a thin layer or film comprising (1) a NC material, (2) high-refractive index material and (3) binder, in said thin layer or film the NC material and the high-refractive index particles

form two layers having a top layer comprising the high-refractive index particles or having a bottom layer comprising the high-refractive index particles,

or

form an alternated layered structure,

said method comprises the steps of
1) mixing the NC material with the binder material,
2) mixing the high-refractive index particulate material with the binder material,
3) depositing the NC/binder mixture on the substrate by spin coating, drop casting, doctor blading, and/or screen printing,
4) depositing the high-refractive index material/binder mixture on NC/binder mixture by spin coating, drop casting, doctor blading, and/or screen printing,
5) optionally, repeating steps 3) and 4) sequentially as many times as to obtain a layered structure of the emitting light element film with total thickness of 50-500 micrometer, preferably 100-300 micrometer
6) curing of the deposited NC material/high-refractive index particles/binder film.

In one embodiment of the method of generating a thin layer or film comprising (1) a NC material, (2) high-refractive index material and (3) binder, in said thin layer or film the NC material and the high-refractive index particles

form a structure with a gradient refractive index, said method comprising the steps of
1) mixing the NC material with the binder material,
2) depositing the NC/binder mixture on the substrate by spin coating, drop casting, doctor blading, and/or screen printing, thereby ad-mixing high-refractive index particulate material and obtaining a gradually varying ratio between NC and high refractive index material throughout the film thickness
3) curing of the deposited NC material/high-refractive index particles/binder film.

The present disclosure provides a method of generating a thin layer or film comprising (1) a NC material, (2) high-refractive index material and (3) binder, optionally other additives, which are deposited on a substrate, said method comprising the steps of
implementing periodic or non-periodic structures of high-refractive index material on the substrate,
mixing the NC material with the binder material,
depositing the above NC/binder mixture on the substrate comprising the high-refractive index material structure by spin coating, drop casting, doctor blading, and/or screen printing,
curing of the deposited NC material binder film.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is a cross-sectional view illustrating a light emitting element (1) according to an embodiment of the present disclosure. FIG. 1B is a plane view illustrating the light emitting element (1) shown in FIG. 1A.

The light emitting element (1) has the shape of a wheel and is a light emitting element in which a reflective layer (3, with a surface (3S)) and a layer of emissive semiconductor nano(crystal)material (4) comprising NC (5) (and optionally binder (6)) are laminated in order on a surface (2S) of a base material (2) including a thin plate having a circular planar shape an opening (2K) is provided at the centre of the base material (2).
Further details are enclosed in U.S. Pat. No. 9,645,479 B2.

FIG. 2 is a cross-sectional view illustrating a configuration example of a light emitting element as a modification example.

The light emitting element (1A) is a light emitting element in which the layer of emissive semiconductor nano(crystal)material (4) is formed on a surface (2S1) of the base material 2. The surface (2S1) is a rough surface. The light emitting element (1A) is a so-called transmission type light emitting element: the base material (2) is configured of a transparent material and has a property of transmitting the excitation light (EL) with which a rear face (2S2) is irradiated on the side opposite to the surface (2S1).
Further details are enclosed in U.S. Pat. No. 9,645,479 B2.

FIG. 3 is a schematic view illustrating a configuration example of a light source apparatus (10) having a light emitting element (1) of the present disclosure.

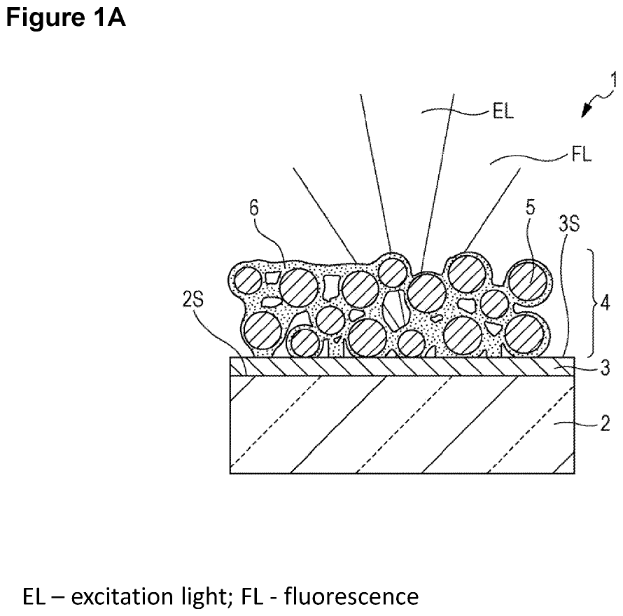

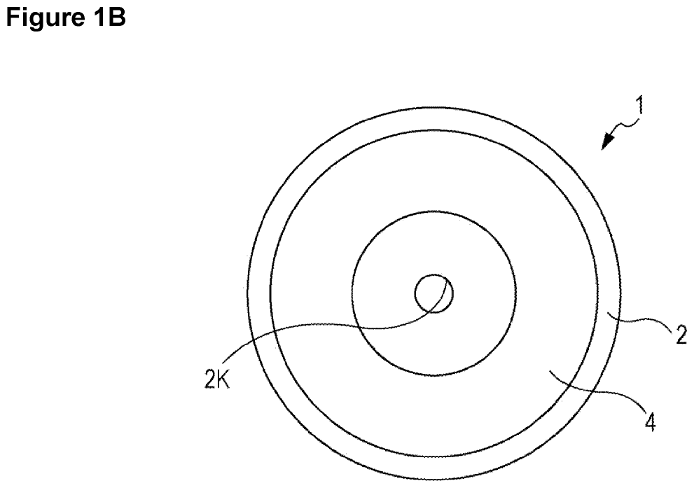

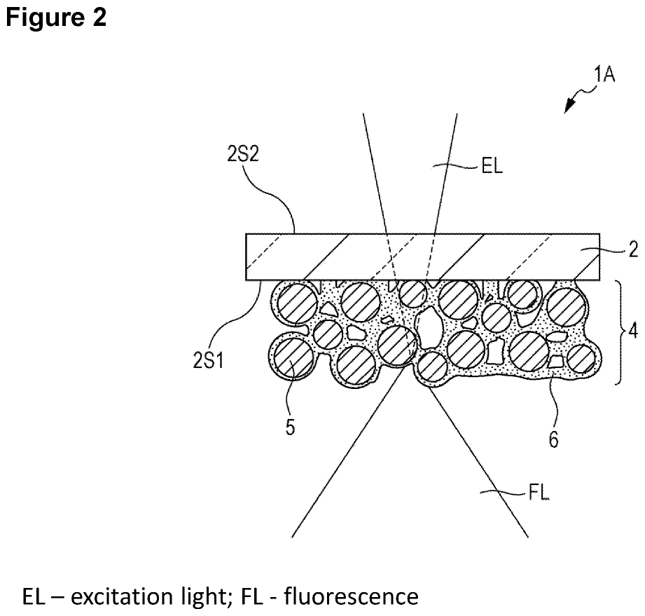

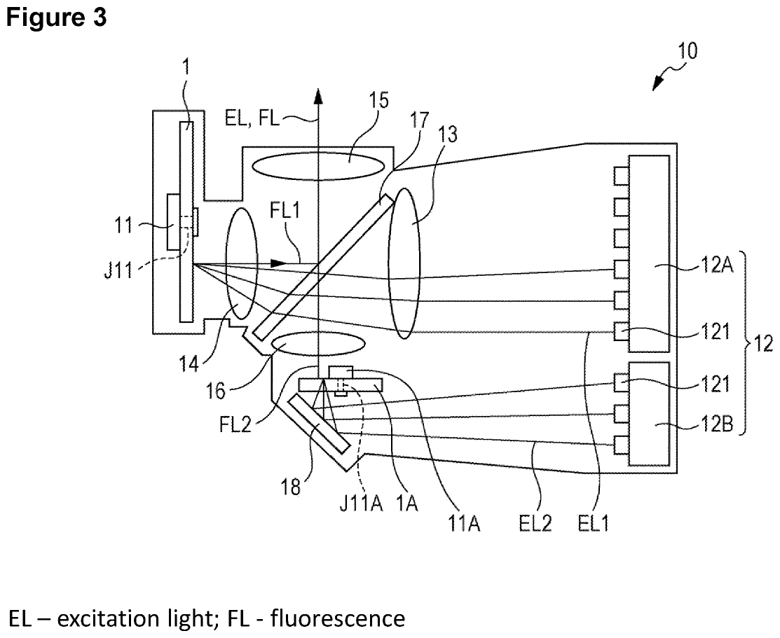

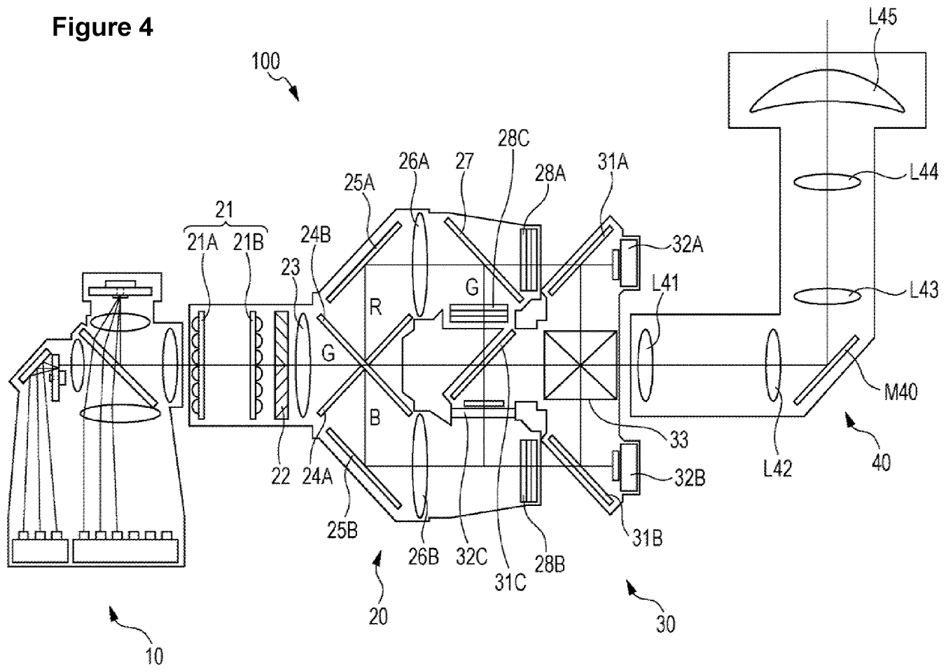

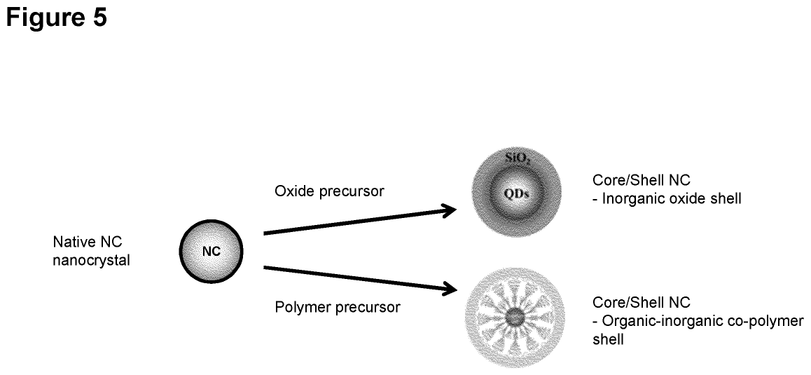

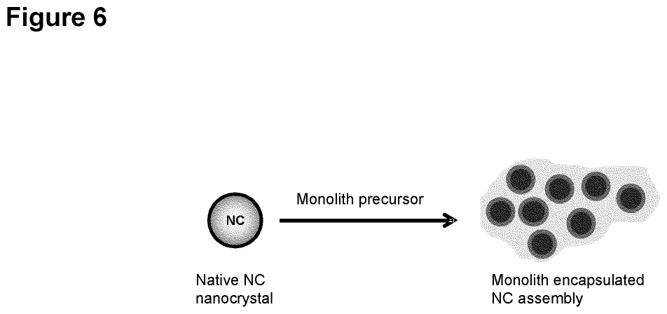

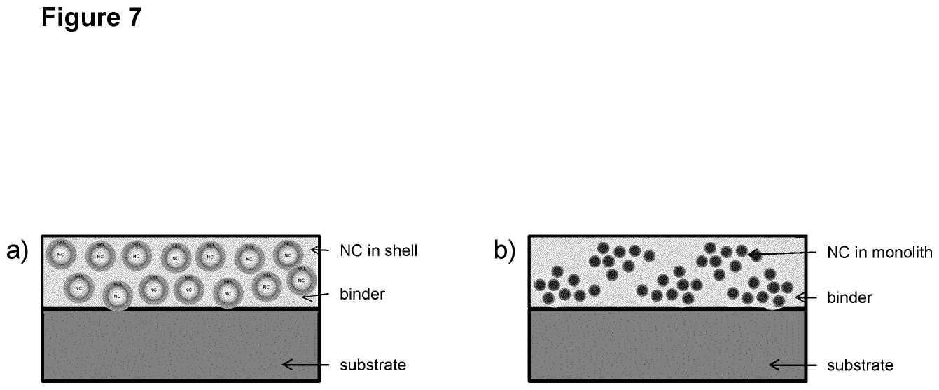

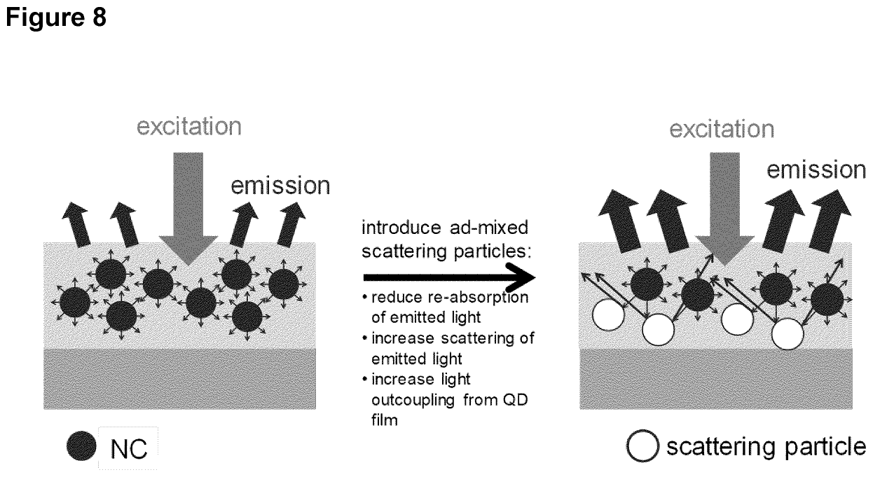

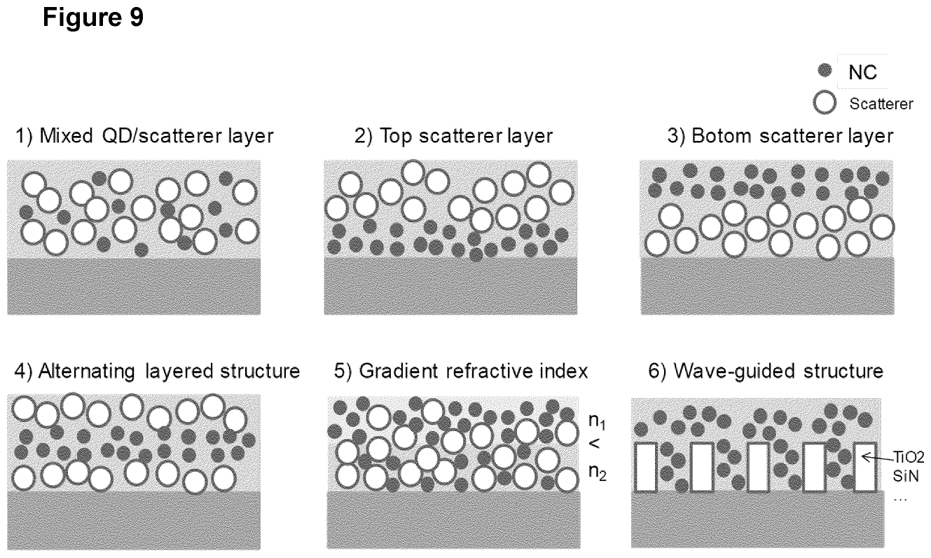

The light source apparatus (10) includes the light emitting elements (1) and (1A), a motor (11) including a rotation axis (J11), a motor (11A) including a rotation axis (J11A), a light source part (12) emitting the excitation light (EL), lenses (13 to 16), a dichroic mirror (17), and a reflection mirror (18). The light emitting element (1) is rotatably supported by the rotation axis (J11) and the light emitting element (1A) is rotatably supported by the rotation axis (J11A). The light source part (12) includes a first laser group (12A) and a second laser group (12B). Both of the first and the second laser groups (12A) and (12B) are groups in which a plurality of semiconductor laser elements (121) which oscillates blue laser light as excitation light are arrayed. Here, for convenience, the excitation light oscillated from the first laser group (12A) is referred to as (EL1) and the excitation light oscillated from the second laser group (12B) is referred to as (EL2).
Further details are enclosed in U.S. Pat. No. 9,645,479 B2.

FIG. 4 is a schematic view illustrating a configuration example of a projector (100) including a light source apparatus (10) having a light emitting element (1) of the present disclosure.

The projector (100) includes the light source apparatus (10), the illumination optical system (20), an image forming part (30), and a projection optical system (40) in order.
The illumination optical system (20) includes, for example, a fly eye lens (21) (21A and 21B), a polarization conversion element (22), a lens (23), dichroic mirrors (24A and 24B), reflection mirrors (25A and 25B), lenses (26A and 26B), a dichroic mirror (27), and polarization plates (28A to 28C) from the position close to the light source apparatus (10).
The image forming part (30) includes reflection type polarization plates (31A to 31C), reflection type liquid crystal panels (32A to 32C), and a dichroic prism (33).
The projection optical system (40) includes lenses (L41 to L45) and a mirror (M40). Further details are enclosed in U.S. Pat. No. 9,645,479 B2.

FIG. 5 shows a schematic representation of NC encapsulation in protective shell.

FIG. 6 shows a schematic representation of NC encapsulation in microscopic monolith structure.

FIG. 7 shows a schematic representation of NC/binder thin film on a solid support:

a) shell-encapsulated NC; and b) monolith encapsulated NC.

FIG. 8 shows schematically the concept of improved light outcoupling through introduction of high-refractive index particles.

FIG. 9 shows examples of structures to realize improved light outcoupling:

1)-5) by ad mixing high refractive index particles, and
6) implementation of periodic or waveguide structures.

### DETAILED DESCRIPTION OF THE EMBODIMENTS

As discussed above, the internal quantum efficiency of NC nanocrystals has achieved near 100%, whereas, the external quantum efficiency of NC-based light source remains below ˜15% because of losses due to concentration dependent multi-particle effects, e.g. re-absorption of the emitted photoluminescent light, emission quenching due to resonant energy transfer between neighbouring NC or thermal quenching due to local heating of the NC.

To increase the efficiency of the NC-based projector source, a solution is proposed in which the outcoupling of the radiation emitted by the NC materials is enhanced through the introduction of light-scattering component(s) in the NC film.

The present disclosure provides a light emitting element. Said light emitting element comprises

(1) emissive semiconductor nano(crystal)material(s) (NC) and

(2) high-refractive index material
preferably in the form of
(2a) particles or
(2b) periodic structures, or
(2c) non periodic structures,

and

(3) binder in which the NC material and the high refractive index material are embedded.

The light emitting element emits photo luminescence light, by being excited with light emitted from a light source, such as in a light source apparatus of the present disclosure or a projector device of the present disclosure.

In one embodiment, said emissive semiconductor nano(crystal)material(s) comprise preferably quantum dots (QD) or perovskite materials.

In particular, said emissive semiconductor nano(crystal)material(s) comprise elements of several groups of the periodic system, such as but not limited to:

(i) type II/VI semiconductor QD materials,
such as CdS, CdSe, CdTe, ZnS, ZnSe, ZnTe, CdSe/ZnS, CdSe/CdS, CdSe/ZnSe, CdTe/CdS, CdTe/ZnS, CdTe/CdS/ZnS,

(ii) type III/V semiconductor QD materials,
such as InP, InAs, GaAs,

(iii) group IV-VI elements,
such as PbSe, PbS, PbTe,

(iv) group IB-(III)-VI elements,
such as CuInS₂, AgInS₂, Ag₂Se, Ag₂S; CuInZnS/ZnS,

(v) group IV elements,
such as silicon QDs (Si QDs), carbon dots (C-dots), graphene QDs (GQDs), and/or

(vi) metal and organometallic halide perovskite materials,
such as organometallic and mixed metal perovskites,
   Pb-based CsPbX₃; (CH₃NH₃)PbX₃, wherein X=Cl, Br, I, or their halide mixtures,
   Sn-based CsSnX₃, wherein X=Cl, Cl_{0.5}Br_{0.5}, Br, Br_{0.5}I_{0.5}, I,
   Ge-based (RbₓCs₁₋ₓ)GeBr₃; CsGe(BrₓCl₁₋ₓ)₃; CH₃NH₃GeX₃, wherein X=Cl, Br, I,
   Bi-based CsA₃Bi₂X₉, wherein X=Cl, Br, I; A=CH₃NH₃; (NH₄)₃Bi₂I₉; (CH₃NH₃)₃(Bi₂I₉),
   Sb-based (NH₄)₃Sb₂IₓBr₉₋ₓ (0<x<9); (CH₃NH₃)₃Sb₂I₉, Cs₃Sb₂I₉,
   InAg-based Cs₂InAgCl₆.

In one embodiment, said emissive semiconductor nano(crystal)material(s) have dimensional structure(s),

such as micron sized particles, nanostructured particles e.g. three dimensional (3D) (nanoparticles, nanodotsbulk nanomaterials), two-dimensional (2D) (nanoplatelets, nanodisks), one-dimensional (1D) (nanorods, nanowires, nanofibers, nanobelts), micron sized particles, comprising sub-nanometer sized emissive clusters, zero-dimensional (0D) (nanoparticles, nanodots, quantum dots) or sub-nanometer sized emissive clusters.

To increase the efficiency of a NC-based projector source (or light emitting element), the present disclosure provides a light emitting element in which the outcoupling of the radiation emitted by the NC materials is enhanced through the introduction of light-scattering component(s) in the NC film.

For this purpose high-refractive index particles or periodic structures of material transparent in the UV-Vis-NIR range can be added to the NC/binder film. The role of the high-refractive index material is to increase the absorbance of the film, decrease the re-absorption of emitted light from the NC nanocrystals as well as to serve as a wave-guide structure for the outcoupling of the photoluminescent light emitted by the semiconductor nano(crystal) material.

In one embodiment, said high-refractive index material is a material transparent in the UV-Vis range, such as but not limited to:

(i) oxide/nitride materials,
such as ZrO₂, TiO₂, SnO₂, Al₂O₃, HfO₂, AlₓCe_{y}O_{z}, Al₄N₃, ZnO, Ta₂O₅

(ii) II-VI based semiconductors,
such as ZnTe, ZnS, ZnSe,
   and/or

(iii) high-refractive index polymers containing
aromatic groups, halogens (except fluorine), phosphorus, silicon, fullerenes, and organometallic moieties.

In one embodiment where said high-refractive index material is in the form of particles (2a), said particles have a size between 0.001 and 1000 μm, preferably between 0.020 and 0.200 μm.

The particles can have a spherical, platelet-like (such as 2D platelet), polyhedron, facetted polyhedron, needle-like, fiber-like, tetrapod-like or fractal-like shape.

In one embodiment, the NC and the high-refractive index particles are mixed.

In one embodiment, the NC and the high-refractive index particles form two layers having a top layer comprising the high-refractive index particles or having a bottom layer comprising the high-refractive index particles. In one embodiment, the NC and the high-refractive index particles form an alternated layered structure, such as with a top and bottom layer comprising the high-refractive index particles. In one embodiment, the NC and the high-refractive index particles form a structure with a gradient refractive index achieved by varying the ratio between NC material and the high-refractive index particles.

In embodiments of the present disclosure, said high-refractive index material can form periodic or non-periodic (random) structures.

In one embodiment said high-refractive index material is in the form of periodic structures (2b).

The periodic structures can be a wave-guide structure, gratings, pillar arrays, honeycomb structure, 2-D square lattice pattern, ordered microlens array, moth's eye nanostructures.

In one embodiment said high-refractive index material is in the form of non periodic structures (2c).

The non-periodic (random) structures can be nanoporous alumina or other oxide films, quasi-periodic buckling structures, randomly dispersed nanopillar arrays, or the like.

A characteristic lateral feature size/pitch size of both, the periodic and non-periodic structures, is comparable with the wavelength of the emitted photoluminescence light to produce scattering in the UV-Vis spectral range; such as from about 150 to about 800 nanometer, preferably from about 200 to about 700 nanometer.

A characteristic thickness/vertical dimension of both, the periodic and non-periodic structures, can be from about 0.050 μm to about 300 μm, preferably about 0.100 μm to about 200 μm.

In one embodiment, the semiconductor nano(crystal) material (NC) is encapsulated in non-emissive material(s)

(a) in a shell, or

(b) in a monolith.

In one embodiment of the light emitting element, the NC material is encapsulated (a) in a shell, wherein the structure is preferably core/shell, or core/shell/shell, wherein the core is preferably a single NC particle.

The process of shell encapsulation aims for the formation of a core/shell NC material with an example structure as shown in FIG. 5. Preferably, a structure comprising a single NC per shell is produced; the shell thickness can be varied from few nanometer up to ˜1 micrometer. Shell synthesis can be performed within pre-formed emulsion droplets serving as reaction containers, by e.g. sol-gel chemical process in solution using a reverse micro-emulsion procedure.

In said embodiment, the shell has a defined pore size, and the shell thickness is preferably in the range from 1 nm up to 1 μm.

Shell thickness can be between 1 nm and 1,000 nm, preferably between 20 nm and 100 nm.
Shell porosity (expressed as minimum inner open voids size) is preferably between 0.001 nm and 0.5 nm.
Shell permeability to oxygen and humidity (expressed as oxygen transmission rate at 25° C. and 50% relative humidity) is preferably between 0.1 and 5 cm³/(m²·day)

In said embodiment, the shell material is a non-emissive material selected from

(i) inorganic oxide or nitride materials,

such as
SiO₂, Al₂O₃, SiₓAl_{y}O_{z}, B₂O₃, ZrO₂, TiO₂, ZnO, SnO₂,
doped oxides with B, Al, Ti, Zn dopants
Si₄N₃, AlN, BN,
   and/or

(ii) polymer-based composite materials,

such as
organic-inorganic block-co-polymers,

The shell material has preferably a refractive index between 1 and 4, preferably between 1.2 and 1.5.

In said embodiment, the shell serves as a spacer. Also as barrier to oxygen and/or humidity (H₂O) permeation from the environment.

In one embodiment of the light emitting element, the NC material is encapsulated (b) in a monolith, wherein preferably several NC particles (>1 NC/monolith) are embedded into a monolith matrix.

The process of monolith encapsulation aims the formation of a NC-containing material, with example structure shown in FIG. 6. In this embodiment, microscopic crystals/flakes of NC assemblies embedded into a non-permeable matrix are formed. Preferably, single NC particles within the assembly are separated by thin layers of insulating non-emissive material from the monolith matrix.

Monolith properties:
It is a spatially discrete microscopic object with homogeneous microstructure in which multiple NC are embedded;
Monolith object is characterized by its irregular shape, e.g. flake-like, platelet-like, needle-like, grain-like. Single NC within the monolith are separated by thin layers of material from the monolith matrix.
Size of the microscopic monolith objects can be between 0.2 μm and 1,000 μm, preferably between 1 μm and 20 μm.
Porosity (expressed as minimum inner open voids size) is between 0.001 nm and 0.5 nm.
Permeability to oxygen and humidity (expressed as oxygen transmission rate at 25° C. and 50% relative humidity) is between 0.1 and 5 cm³/(m²·day)

In said embodiment, the monolith material is a non-emissive material selected from

(i) inorganic oxide or nitride materials,

such as
SiO₂, Al₂O₃, SiₓAl_{y}O_{z}, B₂O₃, ZrO₂, TiO₂, ZnO, SnO₂,
doped inorganic oxides with B, Al, Ti, Zn, dopants
Si₄N₃, AlN, BN,

(ii) polymer-based materials,

such as
inorganic polysilazanes [—H₂Si—NH— ]ₙ,
   such as e.g. perhydropolysilazane
organic polysilazanes [—R₁R₂Si—NR₃-]ₙ, where R₁, R₂, R₃ are hydrocarbon substituents,
organic-inorganic silazane co-polymers,
   such as PMMA/polysilazane
organic-inorganic silica polymers,
   such as organically modified silicates, silsesquioxanes,
      and/or

(iii) single crystals,

such as
BaTiO₃, CaCO₃, BaSO₄, LiCl, LiF.

In one embodiment, the emissive semiconductor nano(crystal)material(s), preferably quantum dots (QD), further comprise support ligands.

In order to ensure high quantum yield (QY>50%) of the encapsulated QD, support ligands are preferably used to reduce the QY drop during the encapsulation in shell and/or monolith.

In one embodiment, the support ligands are directly ad-mixed to the encapsulation reaction mixture during the encapsulation process and allowed to react with the QD nanocrystals typically before the shell or monolith formation.

In one embodiment, the support ligands are separately reacted with the initial QD material before encapsulation. In this case, a protective ligand shell on the QD is formed which is not exchanged during the encapsulation process, i.e. during the shell or monolith formation.

In said embodiment, said support ligands are added during encapsulation, or they form a ligand shell on the QD.

In said embodiment, the support ligands comprise:

(i) organic ligands,

such as
aliphatic or aromatic amine-terminated tri-, di- and mono-alkoxysilanes,
such as
   aminopropyl tri-alkoxysilane, aminopropyl alkyl di-alkoxysilane, aminopropyl dialkyl mono-alkoxysilane,
aliphatic or aromatic mercapto-terminated tri-, di- and mono-alkoxysilanes,
such as
   mercaptopropyl tri-alkoxysilane, mercaptopropyl alkyl di-alkoxysilane, mercapropropyl dialkyl mono-alkoxysilane,
aliphatic or aromatic amine-terminated tri-, di- and mono-silazanes R₃Si—[NH—SiR₂]ₙ—NH—SiR₃ (R=H, CₙH₂ₙ₊₁),
such as
   Hexamethyldisilazane, N-(Dimethylsilyl)-1,1-dimethylsilanamine, Methyl(phenyl)disilazane, Octamethylcyclotetrasiloxane,
aliphatic or aromatic amine-terminated or mercapro-terminated alcohols,
aliphatic or aromatic amine-terminated or mercapro-terminated carboxy acids,
aliphatic or aromatic amine-terminated or mercapro-terminated phosphines and phosphonic acids,
   and/or

(ii) inorganic ligands,

such as
inorganic metal-containing chalcogenides, e.g. Sn₂S₆⁴⁻, SnTe₄⁴⁻, AsS₃³⁻
inorganic metal-free chalcogenides or hydrochalcogenides, e.g. S²⁻, HS⁻, Se²⁻, HSe⁻, Te²⁻, HTe⁻, TeS₃²⁻, S₂O₃²⁻,
inorganic hydroxyl- or amine-based compounds, e.g. OH⁻ and NH₂⁻.

In one embodiment of the light emitting element, the emissive semiconductor nano(crystal) material(s) (NC) are deposited as a thin layer or film, said thin layer or film comprising (1) said emissive semiconductor nano(crystal) material(s) (NC), (2) said high-refractive index material and (3) said binder, on a substrate.

In one embodiment, for preparation of the light emitting element, NC materials are preferably deposited as a thin layer comprising NC and binder material and ad-mixed high-index particulate material.

In one embodiment, for preparation of the light emitting element, the wave guide structures of high-refractive index material are defined on the substrate by methods such as optical, e-beam or nanoimprint lithography. The NC materials are preferably deposited as a thin layer comprising NC and binder material on the substrate comprising the periodic structures.

In one embodiment, for preparation of the light emitting element, NC materials are preferably deposited as a thin layer comprising NC and binder material on the substrate, and the periodic structures (such as wave-guided structures) of high-refractive index material are implemented on top of the thin layer comprising NC and binder material.

In said embodiments the thickness of the layer or film can be in the range of 1 μm to 1,000 μm, preferably 10 μm to 200 μm.

In said embodiment the loading of NC can be in the range of 0.0001% vol up to 95% vol, preferably between 0.01% vol and 80% vol.

In said embodiment the binder material(s) can be selected from, but are not limited to:
silicone resin polymers
   such as methyl-silicone, phenyl-silicone, methyl-phenyl silicone resin, vinyl silicone resin, and mixtures thereof
siloxane polymers,
   such as methylsiloxane, phenylsiloxane, methyl phenyl siloxane, and mixtures thereof
thermoplastic polymers,
   such as polycarbonate, polystyrene, polyacrylate, polymetylacrylate, polyetherimide, polysulfone, polyethersulfone, polyphenylethersulfone, polyvinylidenefluoride, and mixtures thereof
organic-inorganic silica polymers,
   such as organically modified silicates, silsesquioxanes,
inorganic oxide materials,
   such as SiO₂, Al₂O₃, SiₓAl_{y}O_{z}, ZrO₂, TiO₂, ZnO, SnO₂,
inorganic polysilazanes,
   such as perhydropolysilazane, silazane co-polymers,
ceramic materials,
   such as crystalline oxide, nitride or carbide ceramics,
composite materials,
   such as mixtures of ceramics, oxides, graphene, carbon nanotubes with one of the above mentioned binder materials.

In one embodiment, the light emitting element further comprises a base material as a substrate having a reflective surface.

As discussed above, the present disclosure provides a light source apparatus, comprising

(i) a light source, and

(ii) at least one light emitting element according to the present disclosure, or a plurality of light emitting elements according to the present disclosure.

In one embodiment, the light source is a laser diode, preferably a blue laser diode, or a plurality of laser diodes configured in an array.

Further details are enclosed e.g. in U.S. Pat. No. 9,645,479 B2.

The light emitting element emits fluorescence by being excited with light emitted from the light source.

As discussed above, the present disclosure provides a projector device, comprising

(i) a light source apparatus according to the present disclosure,

(ii) a light modulation element, and

(iii) a projection optical system.

The light modulation element modulates light which is ejected from the light source apparatus. The projection optical system projects light from the light modulation element.

Further details are enclosed e.g. in U.S. Pat. No. 9,645,479 B2.

In one embodiment the projector device can be a projection type image display apparatus which projects a screen of a personal computer, a video footage or the like on a screen.

As discussed above, the present disclosure provides methods of generating a thin layer or film comprising a emissive semiconductor nano(crystal) (NC) material, said thin layer or film comprising (1) the emissive NC material, (2) high-refractive index material and (3) binder, and optionally other additives, which are deposited on a substrate.

In one embodiment, the substrate is a flat piece of glass, ceramic or metal material with reflective surface.

In one embodiment, the NC material is one of non-modified pristine NC nanocrystals, NC encapsulated in shell, and/or NC encapsulated in monolith.

In one embodiment, the binder material serves to hold the NC material and/or the other additives together, and at the same time ensures a good adhesion of the NC film to the substrate.

In one embodiment, the high-refractive index material(s) are as defined herein.

In one embodiment, the binder material(s) are as defined herein.

NC thin film characteristics are preferably:
film thickness between 0.100μ and 2000 μm, preferably 50 μm to 1000 μm, most preferably 100 μm to 500 μm.

In a first aspect, the method of generating a thin layer or film comprises:
mixing the NC material with the binder material,
ad-mixing high-refractive index particulate material with the NC/binder mixture,
depositing the above mixture on the substrate by spin coating, drop casting, doctor blading, and/or screen printing,
curing of the deposited NC material/high-refractive index particles/binder mixture.

In embodiments of the methods of generating a thin layer or film according to the present disclosure in said thin layer or film: the NC and the high-refractive index particles
(i) are mixed,
(ii) form two layers having a top layer comprising the high-refractive index particles or having a bottom layer comprising the high-refractive index particles,
(iii) form an alternated layered structure, and/or
(iv) form a structure with a gradient refractive index.

In one embodiment of the first aspect, the method of generating a thin layer or film generates a thin layer or film wherein the NC material and the high-refractive index particles

form two layers having a top layer comprising the high-refractive index particles or having a bottom layer comprising the high-refractive index particles, or

form an alternated layered structure,

wherein said method comprises the steps of
1) mixing the NC material with the binder material,
2) mixing the high-refractive index particulate material with the binder material,
3) depositing the NC/binder mixture on the substrate by spin coating, drop casting, doctor blading, and/or screen printing,
4) depositing the high-refractive index material/binder mixture on NC/binder mixture by spin coating, drop casting, doctor blading, and/or screen printing,
5) optionally, repeating steps 3) and 4) sequentially as many times as to obtain a layered structure of the emitting light element film with total thickness of 50-500 micrometer, preferably 100-300 micrometer, and
6) curing of the deposited NC material/high-refractive index particles/binder film.

Said layered structure can start with either NC/binder material or with high-refractive index material/binder material, and can be finished with either NC/binder material or with high-refractive index material/binder material layer.

In another embodiment of the first aspect, the method of generating a thin layer or film generates a thin layer or film wherein the NC material and the high-refractive index particles

form a structure with a gradient refractive index,

wherein said method comprises the steps of
1) mixing the NC material with the binder material,
2) depositing the NC/binder mixture on the substrate by spin coating, drop casting, doctor blading, and/or screen printing, thereby ad-mixing high-refractive index particulate material and obtaining a gradually varying ratio between NC and high refractive index material throughout the film thickness
3) curing of the deposited NC material/high-refractive index particles/binder film.

In a second aspect, the method of generating a thin layer or film comprises:
implementing periodic structures (such as wave-guided structures) or non-periodic structures of high-refractive index material on the substrate,
mixing the NC material with the binder material,
depositing the above mixture on the substrate by spin coating, drop casting, doctor blading, and/or screen printing,
curing of the deposited NC material/high-refractive index material structure/binder mixture.

In a fourth aspect, the method of generating a thin layer or film comprises:
mixing the NC material with the binder material,
depositing the above mixture on the substrate by spin coating, drop casting, doctor blading, and/or screen printing,
curing of the deposited NC material/binder mixture.
implementing periodic structures (such as wave-guided structures) or non-periodic structures of high-refractive index material on the layer of NC material/binder

Binder curing is done by heat exposure (thermal curing), UV exposure (UV curing), and/or chemical curing.

In one embodiment, binder curing conditions for film preparation are between complete inert (0% oxygen, 0% relative humidity) to ambient (21% oxygen, up to 100% relative humidity); and/or temperature of binder curing is between ambient (22° C.) and 180° C.; and/or UV exposure for binder curing is between 1 J/cm2 and 16 kJ/cm² preferably between 10 J/cm² and 10 J/cm².

Note that the present technology can also be configured as described below.

(1) A light emitting element

comprising (1) emissive semiconductor nano(crystal) (NC) material(s), (2) high-refractive index material, preferably in the form of (2a) particles, (2b) periodic structures or (2c) non-periodic structures, and

(3) binder in which the NC material and the high refractive index material are embedded.

(2) The light emitting element of embodiment (1), wherein said emissive semiconductor nano(crystal)material(s), preferably quantum dot (QD) materials and perovskite materials, comprise elements of several groups of the periodic system, such as but not limited to:

(i) type II/VI semiconductor QD materials,
such as CdS, CdSe, CdTe, ZnS, ZnSe, ZnTe, CdSe/ZnS, CdSe/CdS, CdSe/ZnSe, CdTe/CdS, CdTe/ZnS, CdTe/CdS/ZnS,

(ii) type III/V semiconductor QD materials,
such as InP, InAs, GaAs,

(iii) group IV-VI elements,
such as PbSe, PbS, PbTe,

(iv) group IB-(III)-VI elements,
such as CuInS₂, AgInS₂, Ag₂Se, Ag₂S; CuInZnS/ZnS,

(v) group IV elements,
such as silicon QDs (Si QDs), carbon dots (C-dots), graphene QDs (GQDs), and/or

(vi) metal and organometallic halide perovskite materials,
such as organometallic and mixed metal perovskites,
   Pb-based CsPbX₃; (CH₃NH₃)PbX₃, wherein X=Cl, Br, I, or their halide mixtures,
   Sn-based CsSnX₃, wherein X=Cl, Cl_{0.5}Br_{0.5}, Br, Br_{0.5}I_{0.5}, I,
   Ge-based (RbₓCs₁₋ₓ)GeBr₃; CsGe(BrₓCl₁₋ₓ)₃; CH₃NH₃GeX₃, wherein X=Cl, Br, I,
   Bi-based CsA₃Bi₂X₉, wherein X=Cl, Br, I; A=CH₃NH₃; (NH₄)₃Bi₂I₉; (CH₃NH₃)₃(Bi₂I₉),
   Sb-based (NH₄)₃Sb₂IₓBr₉₋ₓ (0<x<9); (CH₃NH₃)₃Sb₂I₉; Cs₃Sb₂I₉,
   InAg-based Cs₂InAgCl₆.
      (3) The light emitting element of embodiment (1) or (2), wherein said emissive semiconductor nano(crystal)material(s) have dimensional structure(s), such as micron sized particles, nanostructured particles e.g. three dimensional (3D) (nanoparticles, nanodots, bulk nanomaterials), two-dimensional (2D) (nanoplatelets, nanodisks), one-dimensional (1D) (nanorods, nanowires, nanofibers, nanobelts), micron sized particles, comprising sub-nanometer sized emissive clusters, zero-dimensional (0D) (nanoparticles, nanodots, quantum dots) or sub-nanometer sized emissive clusters.
      (4) The light emitting element of any one of embodiments (1) to (3), wherein said high-refractive index material is a material transparent in the UV-Vis range, such as but not limited to:

(i) oxide/nitride materials,
such as ZrO₂, TiO₂, SnO₂, Al₂O₃, HfO₂, AlₓCe_{y}O_{z}, Al₄N₃, ZnO, Ta₂O₅

(ii) II-VI based semiconductors,
such as ZnTe, ZnS, ZnSe,
   and/or

(iii) high-refractive index polymers containing
aromatic groups, halogens (except fluorine), phosphorus, silicon, fullerenes, and organometallic moieties.
   (5) The light emitting element of any one of embodiments (1) to (4), wherein said high-refractive index particles have a size between 0.001 and 1000 μm, preferably between 0.020 and 0.200 μm,
   and/or wherein the particles have a spherical, 2D platelet, polyhedron, facetted polyhedron, needle-like, or fractal-like shape.
   (6) The light emitting element of any one of claims 1 to 5, wherein the NC and the high-refractive index particles are

mixed,

form two layers having a top layer comprising the high-refractive index particles or having a bottom layer comprising the high-refractive index particles,

form an alternated layered structure, and/or

form a structure with a gradient refractive index.

(7) The light emitting element of any one of embodiments (1) to (4), wherein said high-refractive index material is in the form of (2b) periodic structures, such as a wave-guide structure, or (2c) non-periodic structures,
wherein, preferably, the lateral feature size/pitch size is from about 150 to about 800 nm, more preferably about 200 to about 700 nm,
and/or wherein, preferably, the thickness/vertical dimension is from about 0.05 μm to about 300 μm, more preferably about 0.1 μm to about 200 μm.
(8) The light emitting element of any one of the preceding embodiments, wherein the emissive semiconductor nano(crystal)material(s) (NC) are encapsulated in non-emissive material(s)

(a) in a shell, or

(b) in a monolith.

(9) The light emitting element of embodiment (8), wherein the emissive semiconductor nano(crystal)material(s) are encapsulated (a) in a shell,
wherein the structure is core/shell, or core/shell/shell, wherein the core is preferably a single NC, wherein, preferably, the shell thickness is in the range from 1 nm up to 1 μm, more preferably between 20 nm and 100 nm, and/or shell porosity (expressed as minimum inner open voids size) is preferably between 0.001 nm and 0.5 nm.
wherein the shell material is a non-emissive material selected from

(i) inorganic oxide or nitride materials,

such as
SiO₂, Al₂O₃, SiₓAl_{y}O_{z}, B₂O₃, ZrO₂, TiO₂, ZnO, SnO₂,
doped oxides with B, Al, Ti, Zn dopants
Si₄N₃, AlN, BN,
   and/or

(ii) polymer-based composite materials,

such as
organic-inorganic block-co-polymers,
   and/or wherein, preferably, the shell material has a refractive index between 1 and 4, preferably between 1.2 and 2.5,
   and/or wherein the shell serves as a spacer.
   (10) The light emitting element of embodiment (8), wherein the emissive semiconductor nano(crystal)material(s) (NC) are encapsulated (b) in a monolith,
   wherein the several NCs (>1 NC/monolith) are embedded into a monolith matrix,
   wherein preferably single NC within the assembly are separated by thin layers of insulating non-emissive material from the monolith matrix,
   wherein the monolith material is a non-emissive material selected from

(i) inorganic oxide or nitride materials,

such as
SiO₂, Al₂O₃, SiₓAl_{y}O_{z}, B₂O₃, ZrO₂, TiO₂, ZnO, SnO₂,
doped oxides with B, Al, Ti, Zn dopants
Si₄N₃, AlN, BN,

(ii) polymer-based materials,

such as
inorganic polysilazanes [—H₂Si—NH-]ₙ,
   such as e.g. perhydropolysilazane
organic polysilazanes [—R₁R₂Si—NR₃— ]ₙ, where R₁, R₂, R₃ are hydrocarbon substituents,
organic-inorganic silazane co-polymers,
   such as PMMA/polysilazane
organic-inorganic silica polymers,
   such as organically modified silicates, silsesquioxanes,
      and/or

(iii) single crystals,

such as
BaTiO₃, CaCO₃, BaSO₄, LiCl, LiF.
   (11) The light emitting element of any one of the preceding embodiments, wherein said emissive semiconductor nano(crystal)material(s), preferably QD, further comprise support ligands,
   wherein said support ligands are added during encapsulation, or they form a ligand shell on the QD prior to encapsulation,
   wherein the support ligands comprise:

(i) organic ligands,

such as
aliphatic or aromatic amine-terminated tri-, di- and mono-alkoxysilanes,
such as
   aminopropyl tri-alkoxysilane, aminopropyl alkyl di-alkoxysilane, aminopropyl dialkyl mono-alkoxysilane,
aliphatic or aromatic mercapto-terminated tri-, di- and mono-alkoxysilanes,
such as
   mercaptopropyl tri-alkoxysilane, mercaptopropyl alkyl di-alkoxysilane, mercapropropyl dialkyl mono-alkoxysilane,
aliphatic or aromatic amine-terminated tri-, di- and mono-silazanes R₃Si—[NH—SiR₂]ₙ—NH—SiR₃ (R=H, CₙH₂ₙ₊₁),
such as
   Hexamethyldisilazane, N-(Dimethylsilyl)-1,1-dimethylsilanamine, Methyl(phenyl)disilazane, Octamethylcyclotetrasiloxane,
aliphatic or aromatic amine-terminated or mercapro-terminated alcohols,
aliphatic or aromatic amine-terminated or mercapro-terminated carboxy acids,
aliphatic or aromatic amine-terminated or mercapro-terminated phosphines and phosphonic acids,
   and/or

(ii) inorganic ligands,

such as
inorganic metal-containing chalcogenides, e.g. Sn₂S₆⁴⁻, SnTe₄⁴⁻, AsS₃³⁻
inorganic metal-free chalcogenides or hydrochalcogenides, e.g. S²⁻, HS⁻, Se²⁻, HSe⁻, Te²⁻, HTe⁻, TeS₃²⁻, S₂O₃²⁻,
inorganic hydroxyl- or amine-based compounds, e.g. OH⁻ and NH₂⁻.
   (12) The light emitting element of any one of the preceding embodiments, wherein the semiconductor nano(crystal) material(s) are deposited as a thin layer or film,
   said thin layer or film comprising (1) said semiconductor nano(crystal)material(s), (2) said high-refractive index material and (3) said binder, on a substrate.
   (13) The light emitting element of embodiment (12), wherein
the thickness of the layer or film is in the range of 1 to 1,000 μm, preferably 10 to 200 μm, and/or
the loading of QD is in the range of 0.0001% vol up to 95% vol, preferably between 0.01% vol and 80% vol,
   and/or the binder material(s) can be selected from, but are not limited to:
silicone resin polymers
   such as methyl-silicone, phenyl-silicone, methyl-phenyl silicone resin, vinyl silicone resin, and mixtures thereof
siloxane polymers,
   such as methylsiloxane, phenylsiloxane, methyl phenyl siloxane, and mixtures thereof
thermoplastic polymers,
   such as polycarbonate, polystyrene, polyacrylate, polymetylacrylate, polyetherimide, polysulfone, polyethersulfone, polyphenylethersulfone, polyvinylidenefluoride, and mixtures thereof
organic-inorganic silica polymers,
   such as organically modified silicates, silsesquioxanes,
inorganic oxide materials,
   such as SiO₂, Al₂O₃, SiₓAl_{y}O_{z}, ZrO₂, TiO₂, ZnO, SnO₂,
inorganic polysilazanes,
   such as perhydropolysilazane, silazane co-polymers,
ceramic materials,
   such as crystalline oxide, nitride or carbide ceramics,
composite materials,
   such as mixtures of ceramics, oxides, graphene, carbon nanotubes with one of the above mentioned binder materials.
      (14) The light emitting element of any of the preceding embodiments, further comprising a base material (substrate) having a reflective surface.
      (15) A light source apparatus, comprising
(i) a light source, and
(ii) at least one light emitting element according to any one of embodiments (1) to (14), or a plurality of light emitting elements according to any one of embodiments (1) to (14).
   (16) A projector device, comprising
(i) a light source apparatus according to embodiment (15),
(ii) a light modulation element, and
(iii) a projection optical system.
   (17) A method of generating a thin layer or film comprising (1) a NC material, said thin layer or film comprising (2) high-refractive index material and (3) binder, optionally other additives, which are deposited on a substrate, said method comprising the steps of
mixing the NC material with the binder material,
ad-mixing high-refractive index particulate material,
depositing the above mixture on the substrate by spin coating, drop casting, doctor blading, and/or screen printing,
curing of the deposited NC material/high-refractive index particles/binder film,
   wherein, preferably, binder curing conditions for film preparation are between complete inert (0% oxygen, 0% relative humidity) to ambient (21% oxygen, up to 100% relative humidity); and/or temperature of binder curing is between ambient (22° C.) and 180° C.; and/or UV exposure for binder curing is between 1 J/cm2 and 16 kJ/cm² preferably between 10 J/cm² and 10 J/cm²,
   wherein the high-refractive index particulate material(s) are as defined in embodiment (4), and the binder material(s) are as defined in embodiment (12).
   (18) The method of embodiment (17), wherein in said thin layer or film the NC and the high-refractive index particles
(i) are mixed,
(ii) form two layers having a top layer comprising the high-refractive index particles or having a bottom layer comprising the high-refractive index particles,
(iii) form an alternated layered structure, and/or
(iv) form a structure with a gradient refractive index.
   (19) The method of embodiment (17) or (18), wherein in said thin layer or film the NC material and the high-refractive index particles

form two layers having a top layer comprising the high-refractive index particles or having a bottom layer comprising the high-refractive index particles (ii), or

form an alternated layered structure (iii),

said method comprises the steps of
1) mixing the NC material with the binder material,
2) mixing the high-refractive index particulate material with the binder material,
3) depositing the NC/binder mixture on the substrate by spin coating, drop casting, doctor blading, and/or screen printing,
4) depositing the high-refractive index material/binder mixture on NC/binder mixture by spin coating, drop casting, doctor blading, and/or screen printing,
5) optionally, repeating steps 3) and 4) sequentially as many times as to obtain a layered structure of the emitting light element film with total thickness of 50-500 micrometer, preferably 100-300 micrometer, and
6) curing of the deposited NC material/high-refractive index particles/binder film.
   (20) The method of embodiment (19), wherein said layered structure can start with either NC/binder material or with high-refractive index material/binder material, and can be finished with either NC/binder material or with high-refractive index material/binder material layer.
   (21) The method of embodiment (17) or (18), wherein in said thin layer or film the NC material and the high-refractive index particles form a structure with a gradient refractive index (iv),
   said method comprising the steps of
1) mixing the NC material with the binder material,
2) depositing the NC/binder mixture on the substrate by spin coating, drop casting, doctor blading, and/or screen printing, thereby ad-mixing high-refractive index particulate material and obtaining a gradually varying ratio between NC and high refractive index material throughout the film thickness
3) curing of the deposited NC material/high-refractive index particles/binder film.
   (22) A method of generating a thin layer or film comprising (1) a NC material, said thin layer or film comprising (2) high-refractive index material and (3) binder, optionally other additives, which are deposited on a substrate, said method comprising the steps of
implementing periodic structures (such as wave-guided structures) or non-periodic structures of high-refractive index material on a substrate,
mixing NC material with the binder material,
depositing the above NC/binder mixture on the substrate comprising the high-refractive index material structure by spin coating, drop casting, doctor blading, and/or screen printing,
curing of the deposited NC material/binder film,
   wherein, preferably, binder curing conditions for film preparation are between complete inert (0% oxygen, 0% relative humidity) to ambient (21% oxygen, up to 100% relative humidity); and/or temperature of binder curing is between ambient (22° C.) and 180° C.; and/or UV exposure for binder curing is between 1 J/cm2 and 16 kJ/cm² preferably between 10 J/cm² and 10 J/cm²,
   wherein the high-refractive index particulate material(s) are as defined in embodiment (4), and the binder material(s) are as defined in embodiment (12).

The term “quantum dot”, as used herein, refers semiconductor nanocrystals which can emit monochromatic red, green, or blue light.

The term “high-refractive index” material, as used herein, refers to materials having a refractive index greater than 1.50 (>1.50).

A refractive index is an indicator of how different frequencies and wavelengths of light propagate through a transparent material. Rates of refraction, reflection, and attenuation are considered when calculating the refractive index of transparent media.

The term “shell”, as used herein, refers to a spatially discrete object in which preferably single NC are embedded; the shape of the shell could be spherical, spheroid, rod-like, disk-like, and platelet-like.

The term “monolith”, as used herein, refers to a matrix which is not spherical and is not a bead. A monolith is a semi-dimensional structure which could be described as a flake. A “monolith” is understood as a spatially discrete microscopic object with homogeneous microstructure in which multiple NC are embedded; monolith object is characterized by its irregular shape, e.g. flake-like, platelet-like, needle-like, grain-like. Single NC within the monolith are separated by thin layers of material from the monolith matrix. Size of the microscopic monolith objects can be between 0.2 μm and 1000 μm, preferably between 1 μm and 20 μm.

The present invention relates to emissive semiconductor nano(crystal)material(s) preferably quantum dots (QD) or perovskite materials,—as light emitting material implemented in a solid state projector light source with the purpose to improve the light outcoupling, the quantum efficiency, the spectral properties and the colour rendering capabilities.

Furthermore, the present invention is related to a projector light source using such emissive materials.

The present disclosure provides the following features:
NC emissive materials with internal quantum efficiency (quantum yield) >50%
projector light source with improved quantum efficiency, thermal stability and light coupling efficiency based on the above mentioned NC emissive materials.

The present disclosure provides:
High external quantum efficiency;
Improvement of light outcoupling efficiency;
Solution-based processing possible/no vacuum technique needed.

### EXAMPLES

### Example 1

### Examples of Light Coupling Enhancement

Enhancement of photoluminescence intensity in NC films upon adding ad-mixed high refractive material particles to the NC/binder film is demonstrated by the following examples (Table 1).

The photoluminescence intensity enhancement of the NC films was assessed as the ratio between the integrated emitted intensity of the NC/binder film comprising the high refractive material particles and the integrated emitted intensity of the NC/binder film without the high refractive material particles.

TABLE 1
Photoluminescence intensity enhancement in NC films after adding ad-
mixed High refractive material particles to the NC/binder films.

| | High | High | | Photolumi- |
|---|---|---|---|---|
| | refractive | refractive | | nescence |
| | material | material | | intensity |
| | particle | particle | Binder for | enhancement |
| NC type | type | content (% wt) | film making | (%) |
| CdSeZnS | none | 0 | silicone resin | — |
| | TiO₂ | 5 | silicone resin | 11 |
| | ZrO₂ | 5 | silicone resin | 33 |

1. A light emitting elements, comprising:
emissive semiconductor nano(crystal) (NC) materials,
high-refractive index material, in a form of particles, periodic structures, or non-periodic structures, and
a binder in which the NC material and the high refractive index material are embedded.

2. The light emitting element of claim 1, wherein said emissive semiconductor NC materials include quantum dot (QD) materials and perovskite materials, and comprise elements from several groups of the periodic system, the groups including:
(i) type II/VI semiconductor QD materials, including CdS, CdSe, CdTe, ZnS, ZnSe, ZnTe, CdSe/ZnS, CdSe/CdS, CdSe/ZnSe, CdTe/CdS, CdTe/ZnS, and CdTe/CdS/ZnS,
(ii) type III/V semiconductor QD materials, including InP, InAs, and GaAs,
(iii) group IV-VI elements, including PbSe, PbS, and PbTe,
(iv) group IB-(III)-VI elements, including CuInS₂, AgInS₂, Ag₂Se, Ag₂S; and CuInZnS/ZnS,
(v) group IV elements, including silicon QDs (Si QDs), carbon dots (C-dots), and graphene QDs (GQDs), and
(vi) metal and organometallic halide perovskite materials, including organometallic and mixed metal perovskites,
Pb-based CsPbX₃; (CH₃NH₃)PbX₃, wherein X=Cl, Br, I, or their halide mixtures,
Sn-based CsSnX₃, wherein X=Cl, Cl_{0.5}Br_{0.5}, Br, Br_{0.5}I_{0.5}, I,
Ge-based (RbₓCs₁₋ₓ)GeBr₃; CsGe(BrₓCl₁₋ₓ)₃; CH₃NH₃GeX₃, wherein X=Cl, Br, I,
Bi-based CsA₃Bi₂X₉, wherein X=Cl, Br, I; A=CH₃NH₃; (NH₄)₃Bi₂I₉; (CH₃NH₃)₃(Bi₂I₉),
Sb-based (NH₄)₃Sb₂IₓBr₉₋ₓ (0<x<9); (CH₃NH₃)₃Sb₂I₉; Cs₃Sb₂I₉, and
InAg-based Cs₂InAgCl₆.

3. The light emitting element of claim 1, wherein said emissive semiconductor NC materials have dimensional structures, including
micron sized particles, nanostructured particles including three dimensional (3D) (nanoparticles, nanodots, bulk nanomaterials), two-dimensional (2D) (nanoplatelets, nanodisks), one-dimensional (1D) (nanorods, nanowires, nanofibers, nanobelts), micron sized particles, comprising sub-nanometer sized emissive clusters, zero-dimensional (0D) (nanoparticles, nanodots, quantum dots), or sub-nanometer sized emissive clusters.

4. The light emitting element of claim 1, wherein said high-refractive index material is a material transparent in the UV-Vis range, including at least one of:
(i) oxide/nitride materials, including ZrO₂, TiO₂, SnO₂, Al₂O₃, HfO₂, AlₓCe_{y}O_{z}, Al₄N₃, ZnO, and Ta₂O₅,
(ii) II-VI based semiconductors, including ZnTe, ZnS, and ZnSe, and
(iii) high-refractive index polymers containing aromatic groups, halogens (except fluorine), phosphorus, silicon, fullerenes, and organometallic moieties,
wherein said high-refractive index particles have a size between 0.001 and 1000 μm, and/or
wherein the particles have a spherical, 2D platelet, polyhedron, facetted polyhedron, needle-like, or fractal-like shape.

5. The light emitting element of claim 1, wherein the NC and the high-refractive index particles are at least one of
mixed,
form two layers having a top layer comprising the high-refractive index particles or having a bottom layer comprising the high-refractive index particles,
form an alternated layered structure, and
form a structure with a gradient refractive index.

6. The light emitting element of claim 1, wherein said high-refractive index material is in the form of the periodic structures, including a wave-guide structure, or the non-periodic structures,
wherein the lateral feature size/pitch size is from about 150 to about 800 nm, and/or
wherein the thickness/vertical dimension is from about 0.05 μm to about 300 μm.

7. The light emitting element of claim 1, wherein the emissive semiconductor NC materials are encapsulated in non-emissive materials
in a shell, or
in a monolith.

8. The light emitting element of claim 7, wherein the emissive semiconductor NC materials are encapsulated in a shell,
wherein the structure is core/shell, or core/shell/shell, wherein the core is a single NC, wherein the shell thickness is in the range from 1 nm up to 1 μm, and/or shell porosity, expressed as minimum inner open voids size, is between 0.001 nm and 0.5 nm,
wherein the shell material is a non-emissive material selected from at least one of
(i) inorganic oxide or nitride materials, including
SiO₂, Al₂O₃, SiₓAl_{y}O_{z}, B₂O₃, ZrO₂, TiO₂, ZnO, and SnO₂,
doped oxides with B, Al, Ti, Zn dopants, and
Si₄N₃, AN, and BN,
and
(ii) polymer-based composite materials, including organic-inorganic block-co-polymers,
wherein the shell material has a refractive index between 1 and 4, and/or
wherein the shell serves as a spacer.

9. The light emitting element of claim 7, wherein the emissive semiconductor NC materials are encapsulated in a monolith,
wherein the several NCs (>1 NC/monolith) are embedded into a monolith matrix,
wherein single NC within the assembly are separated by thin layers of insulating non-emissive material from the monolith matrix, and
wherein the monolith material is a non-emissive material selected from at least one of
(i) inorganic oxide or nitride materials, including
SiO₂, Al₂O₃, SiₓAl_{y}O_{z}, B₂O₃, ZrO₂, TiO₂, ZnO, and SnO₂,
doped oxides with B, Al, Ti, and Zn dopants, and
Si₄N₃, AN, and BN,
(ii) polymer-based materials, including
inorganic polysilazanes [—H₂Si—NH—]ₙ, including perhydropolysilazane
organic polysilazanes [—R₁R₂NR₃— ]ₙ, where R₁, R₂, R₃ are hydrocarbon substituents,
organic-inorganic silazane co-polymers, including PMMA/polysilazane, and
organic-inorganic silica polymers, including organically modified silicates, silsesquioxanes,
and
(iii) single crystals, including
BaTiO₃, CaCO₃, BaSO₄, LiCl, and LiF.

10. The light emitting element of claim 1, wherein said emissive semiconductor NC materials, include QD, further comprise support ligands,
wherein said support ligands are added during encapsulation, or form a ligand shell on the QD prior to encapsulation, and
wherein the support ligands comprise at least one of:
(i) organic ligands, including
aliphatic or aromatic amine-terminated tri-, di- and mono-alkoxysilanes, including
aminopropyl tri-alkoxysilane, aminopropyl alkyl di-alkoxy silane, aminopropyl dialkyl mono-alkoxysilane,
aliphatic or aromatic mercapto-terminated tri-, di- and mono-alkoxysilanes, including
mercaptopropyl tri-alkoxysilane, mercaptopropyl alkyl di-alkoxysilane, mercapropropyl dialkyl mono-alkoxysilane,
aliphatic or aromatic amine-terminated tri-, di- and mono-silazanes R₃Si—[NH—SiR₂]ₙ—NH—SiR₃ (R=H, CₙH₂ₙ₊₁), including
Hexamethyldisilazane, N-(Dimethylsilyl)-1,1-dimethylsilanamine, Methyl(phenyl)disilazane, Octamethylcyclotetrasiloxane,
aliphatic or aromatic amine-terminated or mercapro-terminated alcohols,
aliphatic or aromatic amine-terminated or mercapro-terminated carboxy acids, and
aliphatic or aromatic amine-terminated or mercapro-terminated phosphines and phosphonic acids,
and
(ii) inorganic ligands, including
inorganic metal-containing chalcogenides, including Sn₂S₆⁴⁻, SnTe₄⁴⁻, and AsS₃³⁻,
inorganic metal-free chalcogenides or hydrochalcogenides, including S²⁻, HS⁻, Se²⁻, HSe⁻, Te²⁻, HTe⁻, TeS₃²⁻, and S₂O₃²⁻, and
inorganic hydroxyl- or amine-based compounds, including OH⁻, and NH₂⁻.

11. The light emitting element of claim 1, wherein the semiconductor NC materials are deposited as a thin layer or film,
said thin layer or film comprising said semiconductor NC materials, said high-refractive index material and said binder, on a substrate,
wherein, at least one of (1) the thickness of the layer or film is in the range of 1 to 1,000 μm, and (2) the loading of QD is in the range of 0.0001% vol up to 95% vol, 0.01% vol and 80% vol, and
the binder material(s) can be selected from at least one of:
silicone resin polymers including methyl-silicone, phenyl-silicone, methyl-phenyl silicone resin, vinyl silicone resin, and mixtures thereof,
siloxane polymers, including methylsiloxane, phenylsiloxane, methyl phenyl siloxane, and mixtures thereof,
thermoplastic polymers, such as including polycarbonate, polystyrene, polyacrylate, polymetylacrylate, polyetherimide, polysulfone, polyethersulfone, polyphenylethersulfone, polyvinylidenefluoride, and mixtures thereof,
organic-inorganic silica polymers, including organically modified silicates, silsesquioxanes,
inorganic oxide materials, including SiO₂, Al₂O₃, SiₓAl_{y}O_{z}, ZrO₂, TiO₂, ZnO, and SnO₂,
inorganic polysilazanes, including perhydropolysilazane, and silazane co-polymers,
ceramic materials, including crystalline oxide, nitride, and carbide ceramics, and
composite materials, including mixtures of ceramics, oxides, graphene, carbon nanotubes with one of the binder materials.

12. The light emitting element of claim 1, further comprising a base material having a reflective surface.

13. A light source apparatus, comprising:
a light source, and
at least one light emitting element according to claim 1, or a plurality of light emitting elements according to claim 1.

14. A projector device, comprising:
a light source apparatus according to claim 13,
a light modulation element, and
a projection optical system.

15. A method of generating a thin layer or film comprising a NC material, said thin layer or film comprising high-refractive index material and a binder, which are deposited on a substrate, said method comprising:
mixing the NC material with the binder material,
ad-mixing high-refractive index particulate material,
depositing the mixture on the substrate by at least one of spin coating, drop casting, doctor blading, and screen printing, and
curing the deposited NC material/high-refractive index particles/binder film,
wherein, at least one of (1) binder curing conditions for film preparation are between complete inert (0% oxygen, 0% relative humidity) to ambient (21% oxygen, up to 100% relative humidity); (2) temperature of binder curing is between ambient (22° C.) and 180° C.; and (3) UV exposure for binder curing is between 1 J/cm2 and 16 kJ/cm² between 10 J/cm² and 10 J/cm²,
wherein the high-refractive index particulate materials are as defined in claim 4.

16. The method of claim 15, wherein in said thin layer or film the NC and the high-refractive index particles at least one of
are mixed,
form two layers having a top layer comprising the high-refractive index particles or having a bottom layer comprising the high-refractive index particles,
form an alternated layered structure, and
form a structure with a gradient refractive index.

17. The method of claim 15, wherein, in said thin layer or film, the NC material and the high-refractive index particles
form two layers having a top layer comprising the high-refractive index particles or having a bottom layer comprising the high-refractive index particles, or
form an alternated layered structure,
said method further comprising
mixing the NC material with the binder material,
mixing the high-refractive index particulate material with the binder material,
depositing the NC/binder mixture on the substrate by at least one of spin coating, drop casting, doctor blading, and screen printing,
depositing the high-refractive index material/binder mixture on NC/binder mixture by at least one of spin coating, drop casting, doctor blading, and screen printing,
repeating the depositing steps sequentially as many times as to obtain a layered structure of the emitting light element film with total thickness of 50-500 micrometer, preferably 100-300 micrometer, and
curing the deposited NC material/high-refractive index particles/binder film.

18. The method of claim 17, wherein said layered structure starts with either NC/binder material or with high-refractive index material/binder material, and is finished with either NC/binder material or with high-refractive index material/binder material layer.

19. The method of claim 15, wherein, in said thin layer or film, the NC material and the high-refractive index particles form a structure with a gradient refractive index (iv), said method further comprising
mixing the NC material with the binder material,
depositing the NC/binder mixture on the substrate by at least one of spin coating, drop casting, doctor blading, and screen printing, thereby ad-mixing high-refractive index particulate material and obtaining a gradually varying ratio between NC and high refractive index material throughout the film thickness, and
curing the deposited NC material/high-refractive index particles/binder film.

20. A method of generating a thin layer or film comprising a NC material, said thin layer or film comprising high-refractive index material and binder which are deposited on a substrate, said method comprising:
implementing periodic structures, including as wave-guided structures, or non-periodic structures of high-refractive index material on a substrate,
mixing NC material with the binder material,
depositing the NC/binder mixture on the substrate comprising the high-refractive index material structure by at least one of spin coating, drop casting, doctor blading, and screen printing, and
curing the deposited NC material/binder film,
wherein at least one of (1) binder curing conditions for film preparation are between complete inert (0% oxygen, 0% relative humidity) to ambient (21% oxygen, up to 100% relative humidity); (2) a temperature of binder curing is between ambient (22° C.) and 180° C.; and (3) UV exposure for binder curing is between 1 J/cm2 and 16 kJ/cm² between 10 J/cm² and 10 J/cm², and
wherein the high-refractive index particulate material(s) are as defined in claim 4.
